(19) United States
(12) Patent Application Publication
(10) Pub. No.: US 2019/0212463 A1
(43) Pub. Date: Jul. 11, 2019

(54) Data Quality Assessment of Processed Multi-Component Induction Data

(71) Applicant: Halliburton Energy Services, Inc., Houston, TX (US)

(72) Inventor: Junsheng Hou, Kingwood, TX (US)

(21) Appl. No.: 15/545,878

(22) PCT Filed: Sep. 27, 2016
(86) PCT No.: PCT/US2016/053878

§ 371 Date: Jul. 24, 2017

(51) Int. Cl. G01V 3/38; G01V 3/28; G01V 3/32; E21B 47/12

(52) U.S. Cl. CPC G01V 3/38; E21B 47/122; G01V 3/32; G01V 3/28

(57) ABSTRACT

The quality of processed MCI logging data is assessed using quality indicators (“QIs”) including, for example, an oval-hole effect QI, formation-invasion effect QI, shoulder effect QI, biaxial anisotropy (“BA”) effect QI, or dip-difference effect QI. The QIs are applied to express their respective effects on the formation property data. Once the data quality has been assessed, a QI borehole formation model is selected based upon the assessment. The QI borehole formation model is then applied to determine true formation property data, which is then used to determine formation porosity, saturation, permeability, etc. of the formation.

### FIELD OF THE DISCLOSURE

The present disclosure relates generally to downhole logging and, more specifically, to data quality assessment of multi-component induction (“MCI”) logging measurements in boreholes.

### BACKGROUND

Downhole logging tools are utilized to acquire various characteristics of earth formations traversed by the borehole, as well as data relating to the size and shape of the borehole itself. The collection of information relating to downhole conditions, commonly referred to as “logging,” can be performed by several methods including wireline logging, “logging while drilling” (“LWD”) and “measuring while drilling (“MWD”), which often utilize MCI-based logging tools.

For MCI applications in formation evaluation (e.g., petrophysics and fracture applications), there are at least three data quality assessment issues: (i) data quality assessment of MCI raw measurements; (ii) data quality assessment of processed (i.e., inverted) data such as resistivity and dip/azimuth; and (iii) data quality assessment of calculated petrophysical parameters (e.g., reservoir true resistivity (“Rsd”), laminated shale volume (“Vlam”), and water saturation in formation pore space (“Sw”), and more) from the MCI processed logs.

Generally, the conventional approach evaluates misfit errors to assess the data quality of the inverted horizontal and vertical resistivities and dip before the data is used for petrophysical interpretation. However, the data quality of all inverted data is also dependent on the radially one-dimensional (“R1D”) data library and the MCI sensitivity to different formation parameters. Therefore, a misfit error along is often insufficient to assess the data quality, as a low misfit error does not guarantee the quality of inverted data.

### BRIEF DESCRIPTION OF THE DRAWINGS

FIG. 1 illustrates a 3D side view and a top-down 2D view of a circular borehole formation model used for MCI data processing, according to certain illustrative methods of the present disclosure;

FIG. 2A illustrates MCI components of a 29 in. array vs. formation resistivity Rh in 0D-TI formations;

FIG. 2B plots the dip sensitivity of MCI components vs. formation Rvh in 0D-TI formations;

FIG. 3A plots the weight function of Eq. 12, where the x-axis is the Rh and the y-axis is the weight function of Eq. 12;

FIG. 3B plots the weight function of Eq. 13, where the x-axis is the Rv and the y-axis is the weight function of Eq. 13.

FIG. 3C plots the weight function W^{RvRh} (z, Rₕ^{R1D}, Rᵥ^{R2D});

FIG. 3D plots the weight W^{dip}(z, dip^{v1D});

FIG. 4 plots the transformed (normalized) misfit error function of Eq. 17, which is defined in terms of relative misfit errors of R1D inversion processing;

FIG. 5 is a flow chart of a method 500 for processing MCI logging data, according to illustrative embodiments of the present disclosure;

FIG. 6 is a flow chart of an alternative, more generalized, method 600 for data quality assessment of MCI logging data, according to illustrative embodiments of the present disclosure;

FIGS. 7A and 7B show multiple QI logs for two different 500-ft depth sections from the GOM well, while FIGS. 7C and 7D show multiple QI logs for two different 500-ft depth sections from the Saudi Arabian well;

FIG. 8A illustrates an MCI logging tool, utilized in an LWD application, that acquires MCI measurement signals processed using the illustrative methods described herein; and

FIG. 8B illustrates an alternative embodiment of the present disclosure whereby a wireline MCI logging tool acquires and processes the MCI measurement signals.

### DESCRIPTION OF ILLUSTRATIVE EMBODIMENTS

Illustrative embodiments and related methods of the present disclosure are described below as they might be employed in methods and systems to assess the quality of MCI data. In the interest of clarity, not all features of an actual implementation or method are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methods of the disclosure will become apparent from consideration of the following description and drawings.

As described herein, illustrative systems and methods of the present disclosure are directed to assessing the quality of MCI measurement data acquired in downhole wellbores. In a generalized method, an MCI logging tool is deployed downhole along a wellbore and MCI measurement signals are acquired. The MCI measurement signals are processed using a borehole formation model to thereby calculate preliminary formation property data (e.g., Rh, Rv, dip, dip azimuth). The data quality of the preliminary formation property data is then assessed using one or more quality indicators (“QIs”) including, for example, an oval-hole effect QI, formation-invasion effect QI, shoulder effect QI, biaxial anisotropy (“BA”) effect QI, or dip-difference effect QI. The QIs are applied to express their respective effects on the preliminary formation property data. Once the data quality has been assessed, a QI borehole formation model is selected based upon the data quality assessment. The QI borehole formation model is then applied to determine final formation property data corresponding to MCI measurement signal(s). A formation (petrophysical) interpretation model is then applied to the final formation property data to thereby determine formation porosity, saturation, permeability, etc. of the formation.

The embodiments and methods described herein are disclosed for integrated data quality assessment of inverted resistivity anisotropy (horizontal and vertical resistivities), dip, and dip azimuth (or strike) with multi-sensor log data. In certain embodiments, the multi-sensor log data can include MCI logs, conventional resistivity logs (e.g., ACRt or array lateral logs), multi-arm caliper logs, borehole imager logs, directional logging, and LWD resistivity logs.

Compared to the conventional methods which apply misfit error techniques, methods of the present disclosure provide QIs that incorporate all of the available information from Rh, Rv, Rvh, and dip, plus oval hole, formation invasion, shoulder-bed effect, dip difference and BA information. The described methods lead to more accurate data quality assessments and assist in field checking data quality and formation reservoir solutions, to deeply understand the data quality used for subsequent petrophysical interpretation.

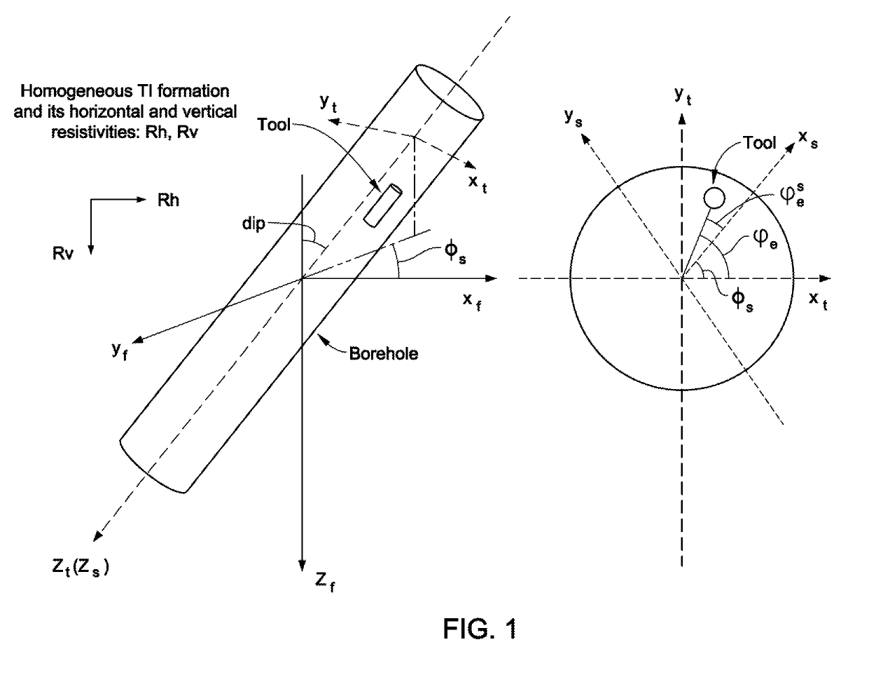

FIG. 1 illustrates a 3D side view and a top-down 2D view of a circular borehole formation model used for MCI data processing, according to certain illustrative methods of the present disclosure. The circular borehole formation model consists of a circular-shaped hole surrounded by a full-space (or 0D) transversely isotropic (“TI”) formation, which is used for R1D inversion and MCI borehole data calculation. The left panel is its 3D view and the right panel is its top 2D view in the xₜ-yₜ plane. In this example, (xₜ, yₜ, zₜ) is the tool/measurement coordinate system, (x_{f}, y_{f}, z_{f}) is the formation coordinate system, and (xₛ, yₛ, zₛ=zₜ) is the strike coordinate system.

The borehole shape is described by a parameter of the circle radius or diameter, frequently denoted by r. In FIG. 1, this model usually consists of a borehole with a circular cross section surrounded by an infinitely thick homogeneous formation. The borehole may be vertical or deviated, and the MCI logging tool can be centralized or decentralized in the borehole. An illustrative MCI logging tool is the Xaminer™-MCI logging tool, which is commercially available through Halliburton Energy Services, Inc. of Houston, Tex.

MCI or triaxial induction logging is conventionally used for delivering formation resistivity anisotropy (horizontal and vertical resistivities), dip, and dip azimuth, but it cannot directly measure all above formation properties. The formation resistivity anisotropy (horizontal and vertical resistivities), dip, and dip azimuth are only obtained by inverting the MCI measurements (apparent conductivity tensors).

In the illustrative methods described herein, however, before the petrophysical processing is conducted, the processed logs undergo a data quality assessment. For MCI real-time processing, an R1D-based inversion may be used. In this inversion, eight unknown parameters from the MCI R1D model (FIG. 1) are inverted. The eight unknown formation parameters may be expressed as a 8-dimensional column vector:

x̅=(x₁,x₂, . . . ,x₈)^{T}=(Rₕ,Rᵥ,dip,d_{ecc},φₑ,ϕₛ,Rₘ,cal)^{T}, Eq.1,

where:

T indicates the vector transposition.

Rh=the formation horizontal resistivity (or horizontal conductivity) in ohm-m.

Rv=the formation vertical resistivity (or vertical conductivity) in ohm-m.

cal=borehole diameter.

Rₘ=the borehole mud resistivity, in ohm-m.

d_{ecc}=the MCI logging tool's eccentric distance (or standoff), given by the distance from the borehole center to the center of the tool.

φₑ=the MCI logging tool eccentricity azimuthal angle in the tool/measurement coordinate system.

dip=the relative dip angle between the formation and borehole, in degrees.

ϕₛ=the dip azimuthal angle, in degrees.

The inversion of the eight unknown R1D model parameters, including horizontal and vertical resistivities and dip, can be expressed in the following constrained nonlinear least-squares optimization problem:

$${min}_{\overline{x}} O ( \overline{x} ) = {min}_{\overline{x}} {‖ W \cdot [ Y - \overline{σ} ( \overline{x} ) ] ‖}^{p} , \qquad Eq . 2$$

and subject to x̅ₘ̅ᵢ̅ₙ̅≤x̅≤x̅ₘ̅ₐ̅ₓ̅ and other constraints.
Here, 0(x̅) is the misfit (error) objective (or cost) function of the constrained optimization problem O(x̅)=∥W·[Y−σ̅(x̅)]∥^{p}, Y is the measured MCI data expressed as an N-dimensional column vector, σ̅(x̅) is the predicted MCI data vector and is computed in the selected borehole-formation R1D model. In certain illustrative methods, this computation may be a direct solution of Maxwell's equations, or it may be a lookup table built from such a solution (e.g., a lookup table of the tool response is built (as a forward model) using the 2D, or 3D codes, and the table includes a sufficient range of all eight parameters). In addition, interpolation techniques, such as linear or non-linear ones (e.g., cubic spline, the Akima spline interpolation, etc.), may be used to estimate responses that fall between discrete parameters.

The predicted data vector is also expressed as an N-dimensional column vector. W is the data weighting matrix, and is expressed as a diagonal block matrix:

x̅ₘ̅ᵢ̅ₙ̅=(xₘᵢₙ⁽¹⁾,xₘᵢₙ⁽²⁾, . . . ,xₘᵢₙ⁽⁸⁾)^{T},x̅ₘ̅ₐ̅ₓ̅=(xₘₐₓ⁽¹⁾,xₘₐₓ⁽²⁾, . . . ,xₘₐₓ⁽⁸⁾)^{T} Eq. 3,

Where xₘₐₓ^{(j)} is an upper bound for the physical parameter xⱼ and xₘᵢₙ^{(j)} is a lower bound for xⱼ, and ∥•∥^{p} denotes the norm of a vector, its power p defines the type of norm used (which is normally chosen as 2).

Based on the borehole model of FIG. 1, an MCI response library can be pre-calculated (before MCI measurement data is acquired by the logging tool) by using a numerical simulation algorithm such as, for example, the three-dimensional finite difference (“3DFD”) method or three-dimensional finite element (“3DFE”). There are many other (stochastic or deterministic) iteration optimization techniques useful to solve the above constrained inversion problems. For example, constrained Newton-based methods can be used for the inversion of all unknown model parameters. Once the MCI response library is pre-populated, it may then be used as the forward engine in processing the subsequent MCI measurement data acquired during logging operations.

However, the iteration process may be stopped when different conditions occur. For example, one of the most commonly used conditions is when the root mean square of the relative misfit error reaches a prescribed value η determined from estimates of noise in the data, i.e.:

(∥O(x̅)∥^{p})^{1/P}≤η Eq.4,

here η is a predetermined priori value that is provided by the user. In the hypothetical case of noise free data, η=0.

The above discussion is provided to illustrate why conventional approaches apply a misfit error analysis to assess the data quality of the inverted horizontal and vertical resistivities and dip before the data is used for petrophysical interpretation. However, the data quality of all inverted data is also dependent on the R1D data library and the MCI sensitivity to different formation parameters. Therefore, a low misfit error does not guarantee that quality inverted Rh, Rv, dip and dip azimuth data is obtained.

Accordingly, the illustrative embodiments and methods described herein apply QI sets to improve the accuracy of calculated formation parameters. Unlike conventional approaches which focus on misfit errors, the QIs of the present disclosure incorporate all of the available information from Rh, Rv, Rvh, and dip plus oval hole, formation invasion, shoulder effect, BA anisotropy, and dip effect between MCI and imager information (used to detect formation structure, e.g., formation dip and fractures).

As previously mentioned, once the MCI response library is pre-populated, it may then be used as the forward engine in processing the subsequent MCI measurement data acquired during logging operations. Such real-time or well-site MCI data processing may be achieved using a R1D library-based inversion. However, the R1D data library usually includes the following limitations: limited to circular hole (no oval hole consideration), no invasion in formation consideration, no shoulder effect consideration, and TI formation consideration. As a result, the R1D data library cannot handle oval holes, invaded formations, strong shoulder effects, or BA anisotropy. Accordingly, in the illustrative methods described herein, to express their effects on the final data-quality effects of Rh, Rv, dip, and dip azimuth parameters, the following quality indicators, or QIs, are provided.

In a first illustrative method, an oval-hole effect QI may be applied. An oval hole may also be termed an ellipse or non-circular hole. As will be understood by those ordinarily skilled in the art having the benefit of this disclosure, a circle is defined as a closed curved shape that is flat. That is, it exists in two dimensions or on a plane. In a circle, all points on the circle are equally far from the center of the circle. In contrast, an ellipse is also a closed curved shape that is flat. However, all points on the ellipse are not the same distance from the center point of the ellipse. Nevertheless, in this example, the oval-hole effect QI is defined as:

$${I}^{oval} = {( 1 - \vert \frac{a - b}{a} \vert )}^{1 / p} . \qquad Eq . 5$$

Here I^{oval} is an oval-hole indicator, and p>0. If one assumes the oval hole is described as an ellipse, then 2a and ab are the major axis and minor axis of the ellipse, respectively. If the hole has a circular cross section, then a=b, and I^{oval}=1, otherwise, I^{oval}<1.0. Moreover, a and b can be obtained from multi-arm caliper measurements.

In a second illustrative method, a formation-invasion QI may be applied in order to take into account instances when wellbore fluids have invaded the formation. The formation-invasion QI indicator may be expressed as:

$${I}^{inva} = {( 1 - \vert \frac{Rxo - Rt}{max ( Rxo , Rt )} \vert )}^{1 / p} or \\ {I}^{inva} = {( 1 - \vert \frac{R 9 \; 0 - R 10}{max ( R 90 , R 10 )} \vert )}^{1 / p} . \qquad Eq . 6.$$

Here I^{inva} is a formation invasion indicator, Rxo and Rt are the formation resistivities in the invaded zone and virgin formation zone, which are obtained from conventional induction processing. If there is no invasion, Rxo=Rt, then I^{inva}=1, otherwise, I^{inva}<1.0.

In a third illustrative method, a shoulder-effect QI may be applied. For the R1D inversion (see FIG. 1), the shoulder-bed effects are always ignored. However, for the vertical one-dimensional inversion (“V1D”), this model (which is being used to apply the shoulder-effect QI in this example) is able to handle the shoulder-bed effects compared to the R1D (FIG. 1) or zero-dimensional (“0D”) transversely isotropic (“TI”) inversion. Therefore, in this illustrative method, the difference between shoulder-bed effects of the V1D are compared to the R1D or 0D inversions to evaluate the shoulder-bed effects on the MCI data. Thus, the shoulder-effect (“SE”) QI for Rh, Rv, dip, and dip azimuth may be expressed as:

$${I}_{x}^{SE} = 1 - \vert \frac{{x}^{{R}_{1} D} - {x}^{{V}_{1} D}}{max ( {x}^{{R}_{1} D} , {x}^{{V}_{1} D} )} \vert . \qquad Eq . 7.$$

Here x=Rh, Rv, dip, and dip azimuth. For example, if x=Rh, then the shoulder-effect QI equation for Rh is:

$${I}_{Rh}^{SE} = 1 - \vert \frac{{Rh}^{{R}_{1} D} - {Rh}^{{V}_{1} D}}{max ( {Rh}^{{R}_{1} D} , {Rh}^{{V}_{1} D} )} \vert . \qquad Eq . 8$$

Here Rh^{R1D} is the R1D inverted Rh, Rh^{V1D} is the V1D inverted Rh. If Rh^{R1D}=Rh^{V1D}, I^{SE}_{RH}=1 (no SE effect), otherwise, I^{SE}_{RH}<1. In similarity, we have I^{SE}_{Rv}, I^{SE}_{dip}, and I^{SE}_{azi}.

In a fourth illustrative method, a BA anisotropy QI may be applied. The BA anisotropy indicator may be expressed as:

$${I}^{BA} = 1 - \vert \frac{Rx - Ry}{max ( Rx , Ry )} \vert . \qquad Eq . 9.$$

Here Rx and Ry are the x- and y-directional resistivity, respectively. Alternatively,

$${I}^{BA} = 1 - \vert \frac{XX - YY}{max ( XX , YY )} \vert . \qquad Eq . 10$$

Here XX and YY are two MCI components after borehole effect correction (“BHC”) or dip correction, or both, respectively.

In a fifth illustrative method, a dip-difference QI may be applied. The dip-difference QI may be expressed as:

$${I}^{dd} = 1 - \vert \frac{Dip\_mci - dip\_image}{max ( {Dip}_{mci} , dip\_image )} \vert . \qquad Eq . 11.$$

Here, Dip_{mci} and dip_image are two dips from the MCI and imager interpretation.

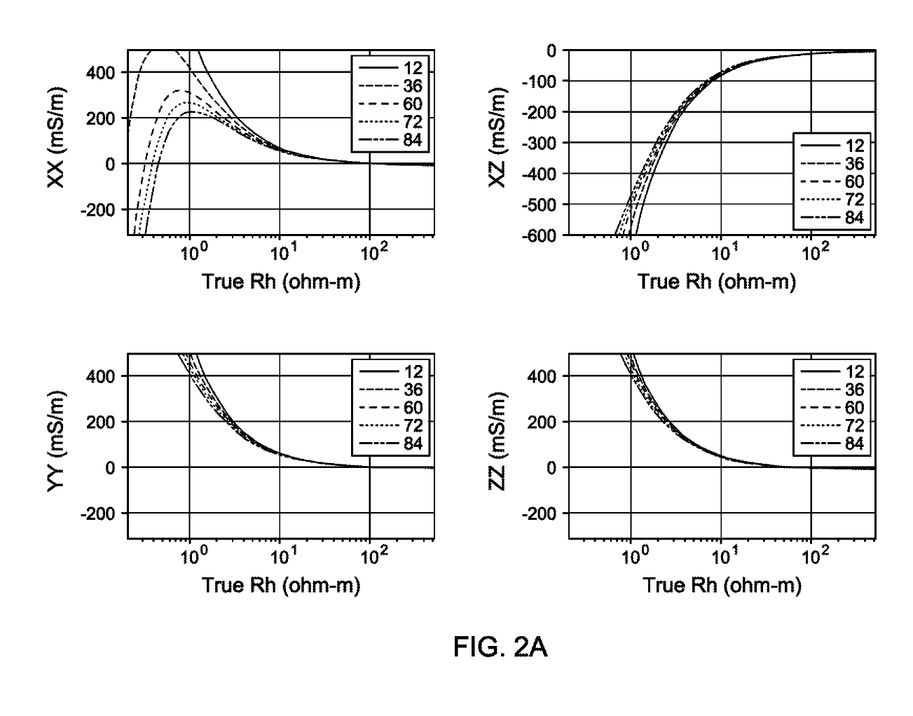

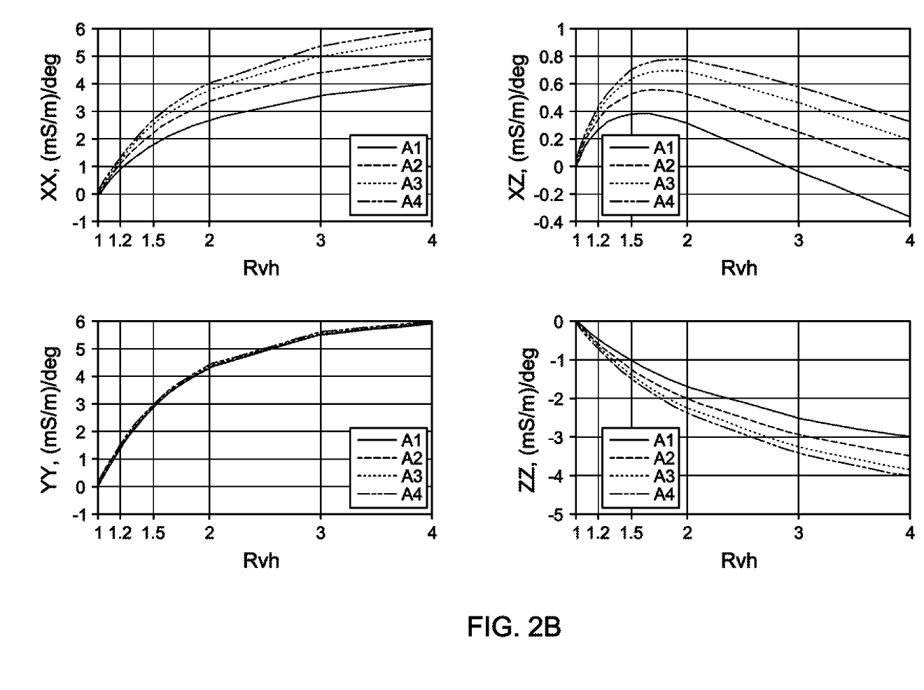

In yet other illustrative methods, weight functions may be applied to the inverted formation property data to reflect dip or resistivity effects on the data. The MCI data has different sensitivities to formation parameters. In low-resistivity formations (both Rh and Rv), the MCI signal has a better signal-to-noise ratio (S/N) or sensitivity comparatively in high-resistivity formations. FIG. 2A illustrates MCI components of a 29 in. array vs. formation resistivity Rh in 0D-TI formations, and is useful to illustrate this concept. FIG. 2A shows four panels. All x-axes represent true horizontal resistivity (Rh) and all y-axes represent XX, XZ, YY, and ZZ, respectively. In other words, the MCI measurements have different sensitivities to formation Rh and Rv (ratio Rvh=Rv/Rh).

In addition, as discussed previously, the R1D inversion is based on the R1D model. In a full-space (or 0D) isotropic formation (i.e., Rvh=1), the MCI measurements have no sensitivity to dip and dip azimuth (see FIG. 2B). FIG. 2B plots the dip sensitivity of MCI components vs. formation Rvh in 0D-TI formations. In FIG. 2B, there are also four panels where all x-axes represent resistivity anisotropy (Rvh) and the y-axes represent dip sensitivity of XX, XZ, YY, and ZZ. Thus, different dip sensitivities are shown for different Rvh values. At Rvh=1, all dip sensitivities=0.0. Therefore, the accuracy of the inverted dip and azimuth from MCI processing is significantly reduced when the anisotropy ratio Rvh is close to 1.

Accordingly, in order to take account of the sensitivity effects on the data quality of the inverted parameters, a number of weight functions that include effects on Rh, Rv (or Rvh), and dip are provided in various illustrative embodiments of the present disclosure. The weight function W^{Rh}(z,R^{R1D}ₕ) is defined in terms of horizontal resistivity Rₕ of the formation:

$${W}^{Rh} ( z , {R}_{h}^{{R}_{1} D} ) = \{ \begin{matrix}{e}^{- {( \frac{{R}_{h}^{{R}_{1} D} - 0.5}{0.12} )}^{2} ,} & if {R}_{h}^{{R}_{1} D} < 0.5 Ω \\ 1.0 , & if 0.5 \leq {R}_{h}^{{R}_{1} D} \leq {50.0}^{Ω} \\ {e}^{- {( \frac{{R}_{h}^{{R}_{1} D} - 50}{20} )}^{2} ,} & if {R}_{h}^{{R}_{1} D} > 50.0 Ω\end{matrix} . \qquad Eq . 12$$

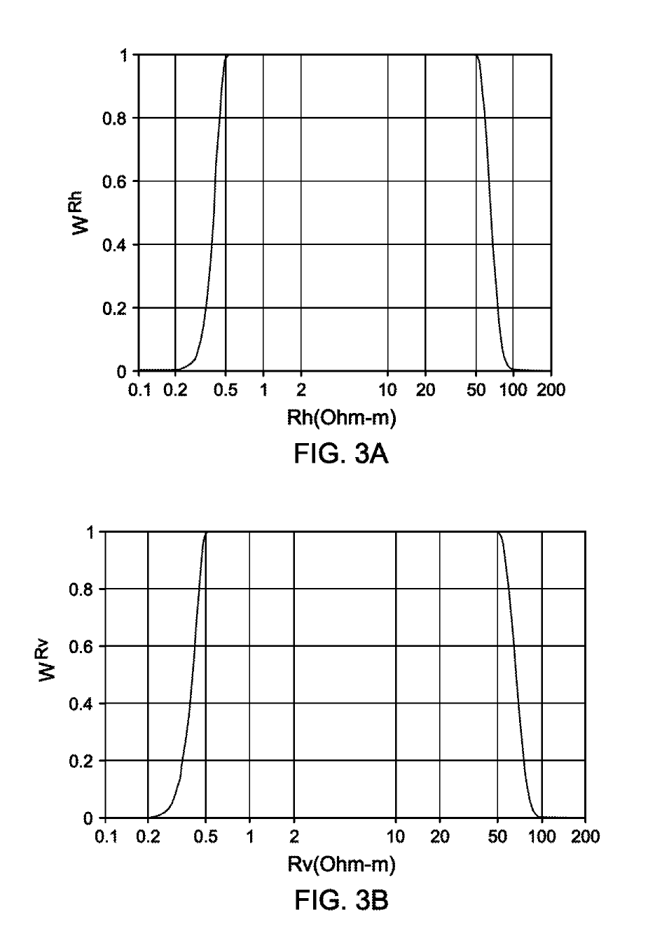

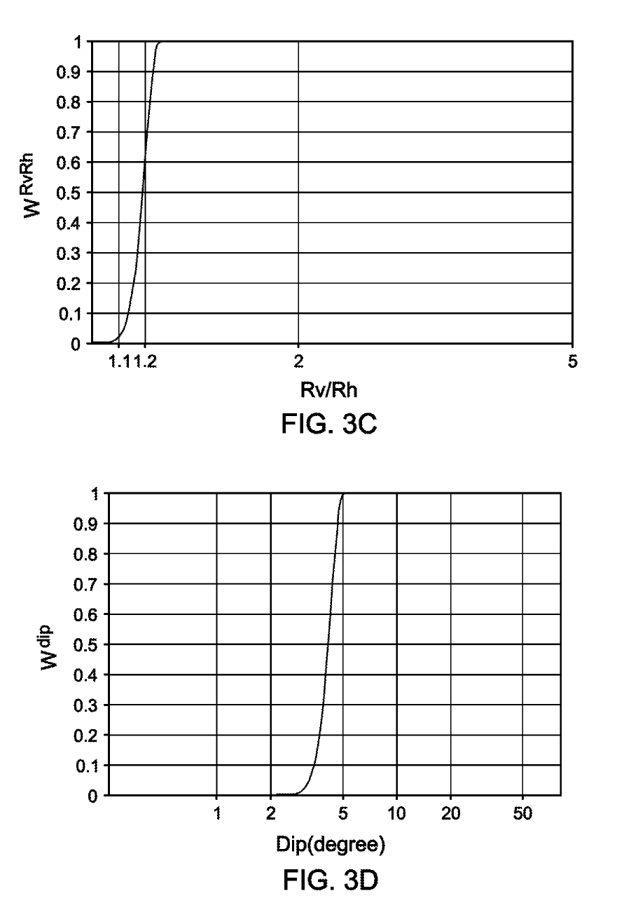

FIG. 3A plots the weight function of Eq. 12, where the x-axis is the Rh and the y-axis is the weight function of Eq. 12. The weight function W^{Rv}(z,R^{R1D}ₕ) is defined in terms of vertical resistivity Rᵥ of the formation where the current logging position z is located:

$${W}^{Rv} ( z , {R}_{v}^{{R}_{1} D} ) = \{ \begin{matrix}{e}^{- {( \frac{{R}_{v}^{{R}_{1} D} - 0.5}{0.12} )}^{2} ,} & if {R}_{v}^{{R}_{1} D} < 0.5 Ω \\ 1.0 , & if 0.5 \leq {R}_{v}^{{R}_{1} D} \leq {50.0}^{Ω} \\ {e}^{- {( \frac{{R}_{v}^{{R}_{1} D} - 50}{20} )}^{2} ,} & if {R}_{v}^{{R}_{1} D} > 50.0 Ω\end{matrix} . \qquad Eq . 13$$

FIG. 3B plots the weight function of Eq. 13, where the x-axis is the Rv and the y-axis is the weight function of Eq. 13.

The weight function W^{RvRh}(z, Rₕ^{R1D}, Rᵥ^{R1D}) is illustrated in FIG. 3C, the x-axis showing the resistivity anisotropic ratio Rvh and the y-axis showing the weight function W^{RvRh}(z, Rₕ^{R1D}, Rᵥ^{R1D}). W^{RvRh}(z, Rₕ^{R1D}, Rᵥ^{R1D}) is a weight function defined in terms of resistivity Rₕ and Rᵥ (anisotropic ratio Rvh=Rv/Rh) of the formation where the current logging position z is located:

$${W}^{RvRh} ( z , {R}_{h}^{{R}_{1} D} , {R}_{v}^{{R}_{1} D} ) = \{ \begin{matrix}{e}^{- {( \frac{{R}_{v}^{{R}_{1} D} / {R}_{h}^{{R}_{1} D} - 1.25}{0.075} )}^{2} ,} & {R}_{v}^{{R}_{1} D} \text{/} {R}_{h}^{{R}_{1} D} < 1.25 \\ 1.0 , & else\end{matrix} , \qquad Eq . 14$$

which is plotted in FIG. 3C.

W^{dip}(z, dip^{v1D}) is a weight function plotted in FIG. 3D, where the x-axis is the formation dip and the y-axis is the weight function of Eq. 15 below. W^{dip}(z, dip^{v1D}) is defined in terms of the dip of the formation where the current logging position z is located:

$${W}^{dip} ( z , {dip}^{{R}_{1} D} ) = \{ \begin{matrix}{e}^{- {( \frac{{dip}^{{R}_{1} D} - 5.0}{1.0} )}^{2} ,} & if {dip}^{{R}_{1} D} < 5.0 deg \\ 1.0 , & else\end{matrix} , \qquad Eq . 15$$

In view of the foregoing discussion, illustrative embodiments and methods of the present disclosure apply the following equations to perform the QI calculations for the data quality assessment of MCI processed logs (Rh, Rv, dip and dip azimuth).

QI_{R}_{ₕ}(z,Rh)=W^{Misfit}(z,Misfit(z))·W^{Misfit2}(z,Misfit2(z))·W^{Rh}W^{Rh}(z,Rₕ^{R1D})·I^{oval}·I^{inva}·I_{Rh}^{SE}·I^{BA} Eq.16a,

QI_{R}_{ᵥ}(z,Rv)=W^{Misfit}(z,Misfit(z))·W^{Misfit2}(z,Misfit2(z))·W^{Rv}(z,Rₕ^{R1D})·I^{oval}·I^{inva}·I_{Rh}^{SE}·I^{BA} Eq.16b,

QI_{Dip}(z,Rh,Rv)=W^{Misfit}(z,Misfit(z))·W^{Misfit2}(z,Misfit2(z))·W^{Rh}(z,R^{R1D}ₕ)·W^{RvRh}(z,R^{R1D}ₕ,R^{R1D}ᵥ)·I^{oval}·I^{inva}·I^{SE}_{dip}·I^{BA}·I^{dip} Eq.16c,

QI_{Azi}(z,Rh,dip,Rvh)=W^{Misfit}(z,Misfit(z))·W^{Misfit2}(z,Misfit2(z))·W^{Rh}(z,R^{R1D}ₕ)·W^{Dip}(z,dip^{R1D})W^{RvRh}(z,R^{R1D}ₕ,R^{R1D}ᵥ)·I^{oval}·I^{inva}·I^{SE}_{Azimuth}·I^{BA} Eq.16d,

Here, QI_{R}_{ₕ}(z, Rh), QI_{R}_{ᵥ}(z, Rv), QI_{Dip}(z, Rh, Rv), and QI_{Azi}(z, Rh, dip, Rvh) are four different QIs; Rₕ^{R1D}, Rᵥ^{R1D}, and Dip^{R1D} are the R1D (or 0D) MCI processing results; W^{Misfit}(z, Misfit (z)) is a transformed (normalized) misfit error function and it is calculated by relative misfit errors of R1D inversion processing, W^{misfit2}(z, Misfit2(z)) is a transformed (normalized) misfit error function and it is calculated by using relative errors among different subarrays of R1D inversion processing, and Misfit (z) is the norm of the difference between measurements and the model.

For example, W^{Misfit}(z, Misfit(z)) may be defined in terms of relative misfit errors of R1D inversion processing. If so, the following equation is used to mathematically express W^{Misfit}(z, misfit(z)):

$${W}^{Misfit} ( z , Misfit ( z ) ) = \{ \begin{matrix}1.0 , & if Misfit ( z ) < 0.05 \\ 0.0 , & if Misfit ( z ) > 0.25 \\ - 5 * Misfit ( z ) + 1.25 , & else\end{matrix} , \qquad Eq . 17$$

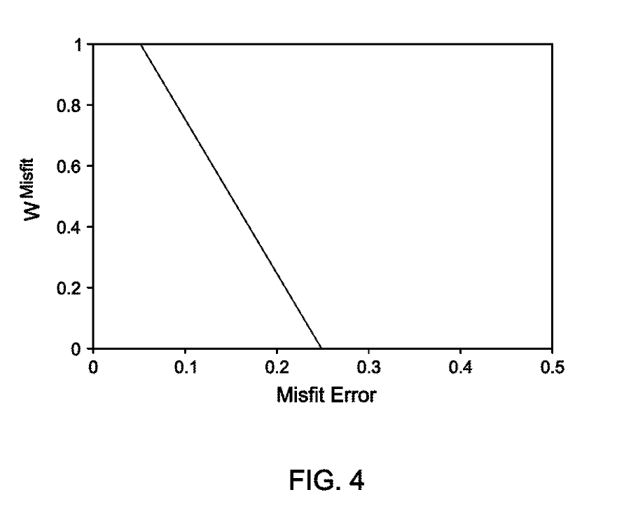

which is illustrated in FIG. 4. More specifically, FIG. 4 plots the transformed (normalized) misfit error function of Eq.17 which is defined in terms of relative misfit errors of R1D inversion processing.

Once inverted Rh, Rv, and dip and azimuth are calculated by the system, the evaluation of the data quality is performed using the QIs previously described. The applied QI set explicitly incorporates all of the available information from Rh, Rv, Rvh, and dip plus oval hole, formation invasion, shoulder effect and BA anisotropy information, which lead to more reasonable data quality assessment. Accordingly, in view of the foregoing, an illustrative QI range for the MCI data may be defined between 0.0-1.0 (or 0-100), in line with three different levels defined as:

(i) 0-0.3 (or 0-30)=bad quality data;

(ii) 0.3-0.6 (or 30-60)=fair quality data;

(iii) 0.6-1.0 (or 60-100)=good quality data.

Once the data quality has been assessed (e.g., bad, fair, or good), the correct borehole formation model may be selected to thereby most accurately calculate the petrophysical parameters in question (e.g., saturation, porosity, permeability, etc.). Here, in certain illustrative embodiments, all QIs may be used as described in preceding equations. If a QI is close to 1, that QI no effect; if another Q1 is close to zero, that QI has a max effect. For example, if the QI assessment indicates the formation is invaded (i.e., the formation-invasion QI is in the range of “bad” data quality, the system may select and apply the formation invasion model to determine formation resistivity, dip and dip azimuth, and then calculate the petrophysical parameters (e.g., porosity, saturation, permeability, etc.) accordingly using any variety of formation interpretation models. Nevertheless, the formation invasion model in this example would reflect that the formation resistivity is a function of the radial distance (e.g., denoted as r) between the borehole center and the invaded position inside formation. In certain other methods, note a “fair” data quality may also necessitate use of specific borehole model.

The QI assessment described herein may be applied easily in the field for real-time MCI data analysis, or to plan or analyze drilling operations. If some factors are assumed to be 1 (i.e., the factors are ignored), the following simplified equations may be also be used in other illustrative methods:

QI_{R}_{ₕ}(z,Rh)=W^{Misfit2}(z,Misfit2(z))·W^{Rh}W^{Rh}(z,Rₕ^{R1D}). Eq.18a.

QI_{R}_{ᵥ}(z,Rv)=W^{Misfit2}(z,Misfit2(z))·W^{Rv}(z,Rᵥ^{R1D}). Eq.18b.

QI_{Dip}(z,Rh,Rv)=W^{Misfit2}(z,Misfit2(z))·W^{Rh}(z,Rₕ^{R1D})·W^{RvRh}(z,Rₕ^{R1D},Rᵥ^{R1D}). Eq.18c.

QI_{Azi}(z,Rh,dip,Rvh)=W^{Misfit2}(z,Misfit2(z))·W^{Rh}(z,Rₕ^{R1D})·W^{Dip}(z,dip^{R1D})·W^{RvRh}(z,Rₕ^{R1D},Rᵥ^{R1D}). Eq.18d.

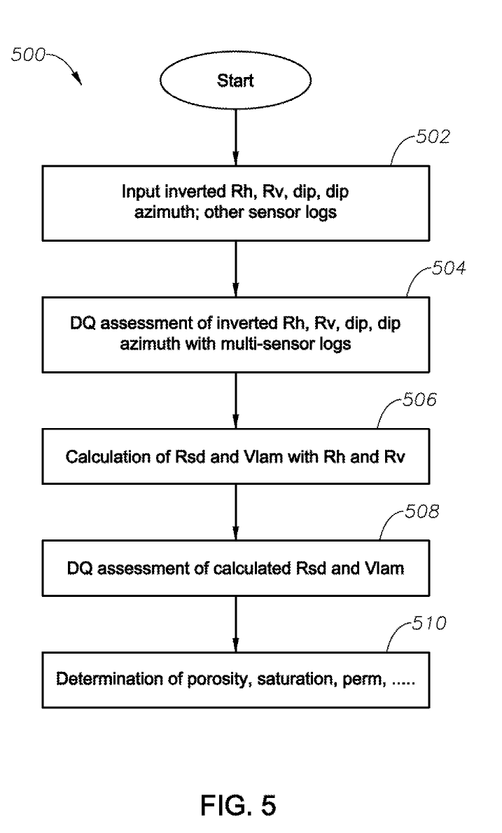

With reference to FIG. 5, an illustrative method of the present disclosure will now be described. FIG. 5 is a flow chart of a method 500 for processing MCI logging data. In certain methods, the MCI logging tool is combined with a multi-arm caliper tool (e.g., Halliburton Energy Services, Inc.'s LOGIQ® Caliper Tool), which is used for determining the borehole shape (i.e., circular or elliptical borehole characteristics) and tool position inside the borehole (e.g., tool eccentricity and its azimuthal angle). Nevertheless, in one method, the logging tool is deployed downhole along a borehole. At block 502, one or more MCI measurement signal(s) of the formation are acquired using the MCI logging tool. The MCI measurement signal(s) are then processed using a borehole formation model. At block 502, formation property data which corresponds to the processed MCI measurement signal(s) are calculated as inverted Rh, Rv, dip and dip azimuth, as well as other sensor logs such as, for example, ACRt logs, multi-arm calipers, and borehole imager data if available.

At block 504, using the illustrative methods described herein, a data quality assessment is then performed on the inverted formation property data with multi-sensor logs. The quality of the data is determined to be good, fair or poor, and the necessary borehole formation model (also referred to herein as the “QI borehole formation model”) is selected accordingly to determine Rh, Rv, dip, and/or dip azimuth. At block 506, a formation interpretation model is then applied to calculate Rsd and Vlam using, e.g., Rh and Rv from the QI borehole formation model. In certain illustrative methods, the data-quality of Rsd and V lam may also be determined at block 508 using methods, such as, for example, resistivity tensor interpretation models. At block 510, the formation interpretation models are then used to determine the petrophysical parameters such as, for example, porosity and saturation, and thereafter used to determine permeability anisotropy and true permeability.

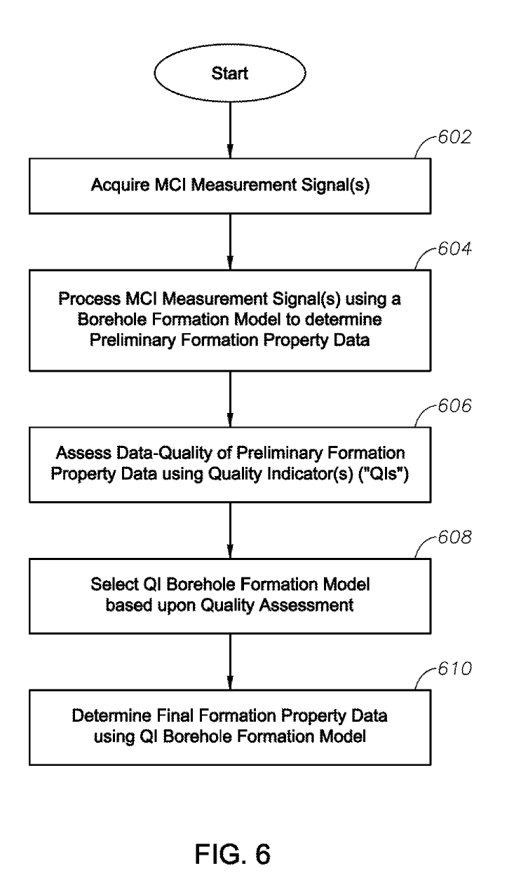

With reference to FIG. 6, an alternative illustrative method of the present disclosure will now be described. FIG. 6 is a flow chart of an alternative, more generalized, method 600 for data quality assessment of MCI logging data. At block 602, a logging tool is positioned downhole and MC measurement signals of the formation are acquired. At block 604, the MCI measurement signals are processed using a borehole formation model to thereby determine preliminary formation property data (e.g., Rh, Rv, dip, azimuth). At block 606, the data quality of the preliminary formation property data is assessed using the QIs, as described herein. Thereafter, at block 608, a QI borehole formation model is selected based upon the data quality assessment. At block 610, the QI borehole formation model is used to determine the final formation property data (e.g., Rh, Rv, dip, azimuth). A formation interpretation model may then be applied to the final formation property data to calculate the petrophysical parameters (e.g., porosity, saturation, permeability, etc.). This data may then be used to plan, conduct, or review various downhole operations.

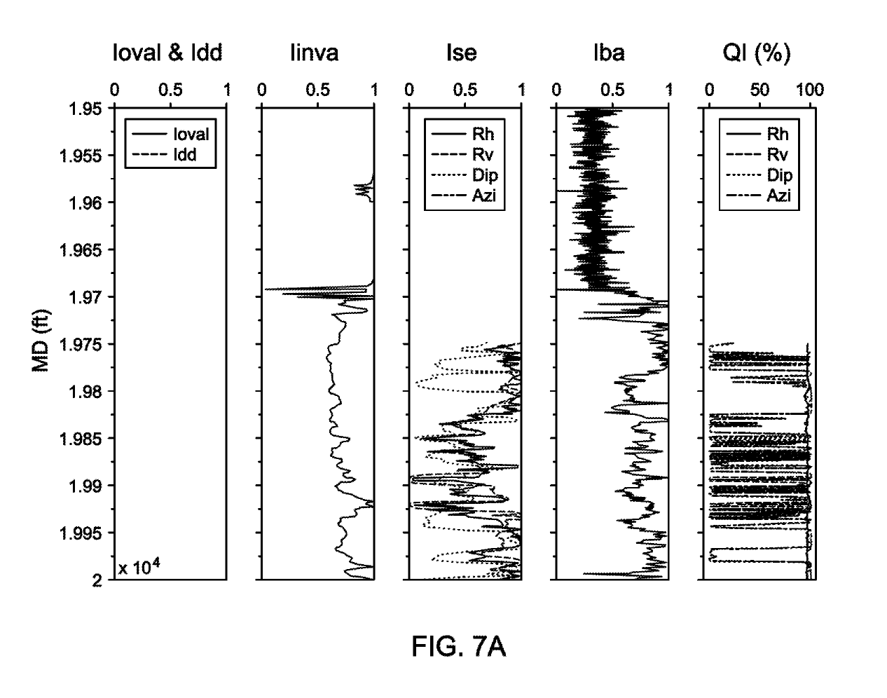

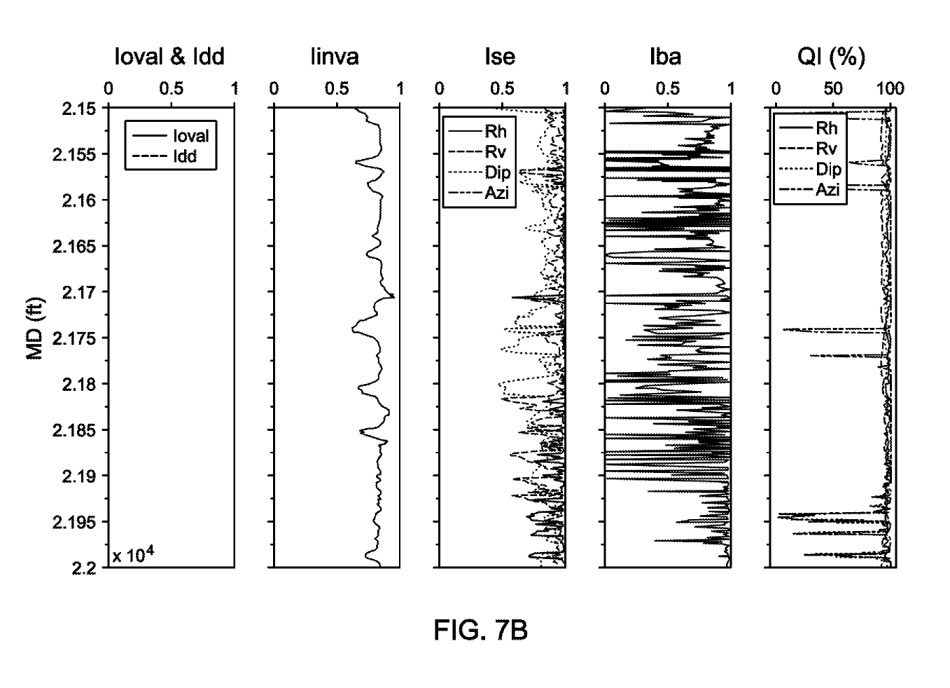

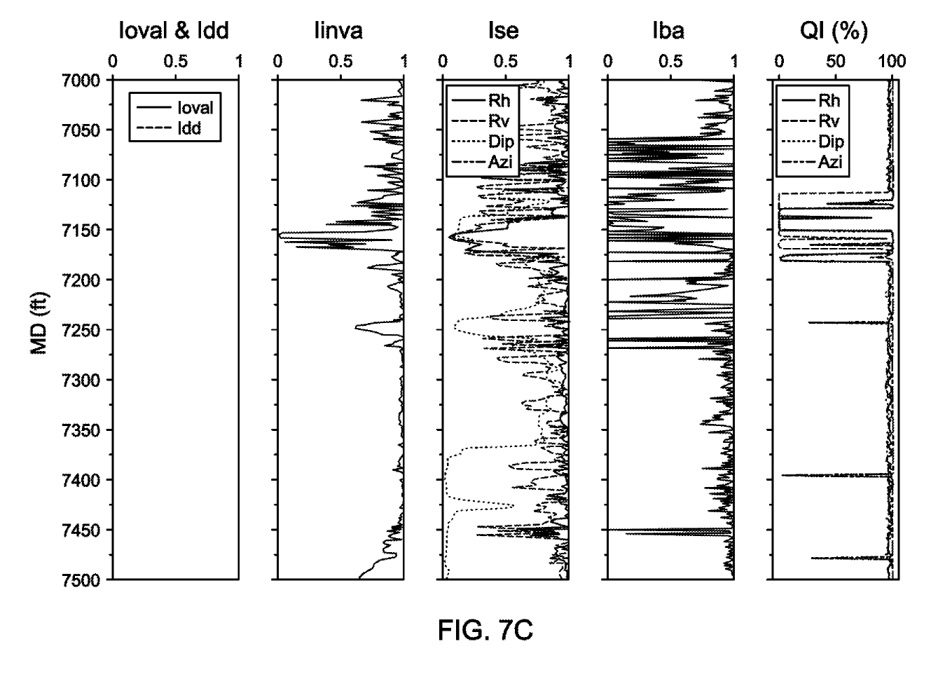

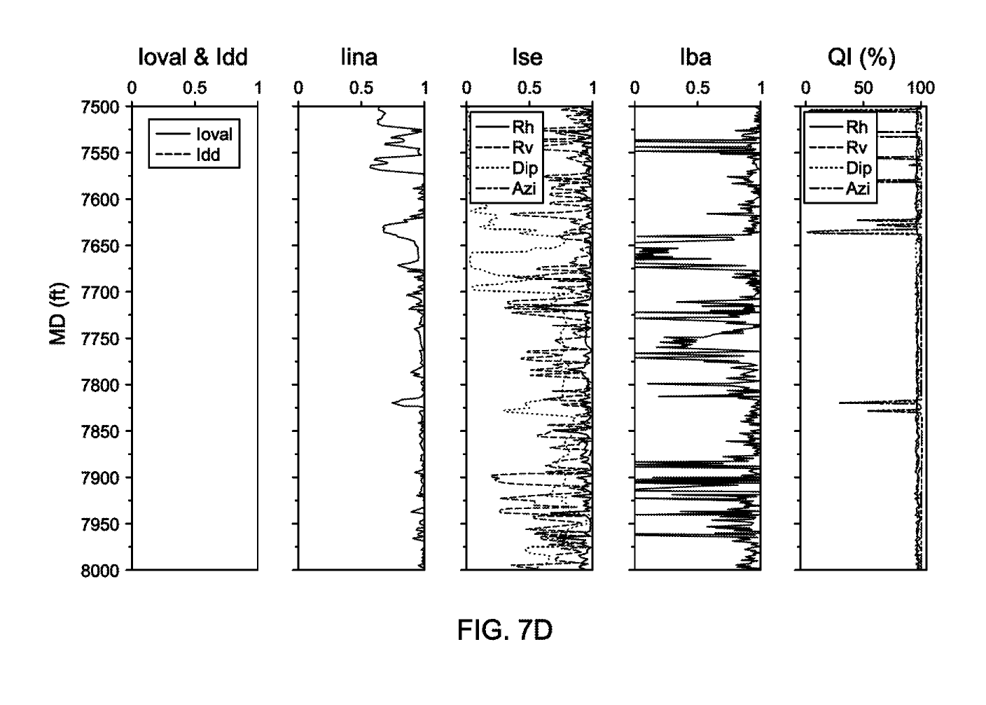

During testing of the present disclosure, the methods described herein were applied to two wells, one in the Gulf of Mexico (“GOM”) and the other in Saudi Arabia. FIGS. 7A and 7B show multiple QI logs generated using the methods herein for two different 500-ft depth sections from the GOM well, while FIGS. 7C and 7D show multiple QI logs for two different 500-ft depth sections from the Saudi Arabian well. Here, Ioval and Idd are the oval-effect quality indicator and dip-difference quality indicator; Iinva is the invasion-effect quality indicator; Ise has four quality indicators for Rh, Rv, dip, and azimuth shoulder effect: I_{Rh}^{SE}, I_{Rv}^{SE}, I_{dip}^{SE}, and I_{azi}^{SE}; Iba is the BA-effect indicator; and the QIs are obtained by using equations 18a-d. Therefore, multiple QI logs may be used for the data quality assessment of the inverted logs (e.g., Rh, Rv, dip and dip azimuth) before they are used for subsequent petrophysical evaluation.

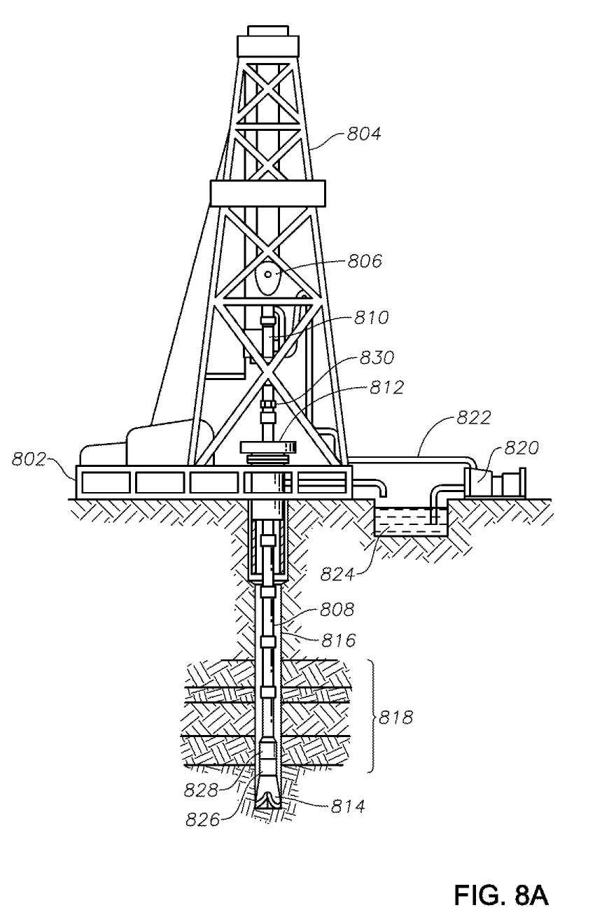

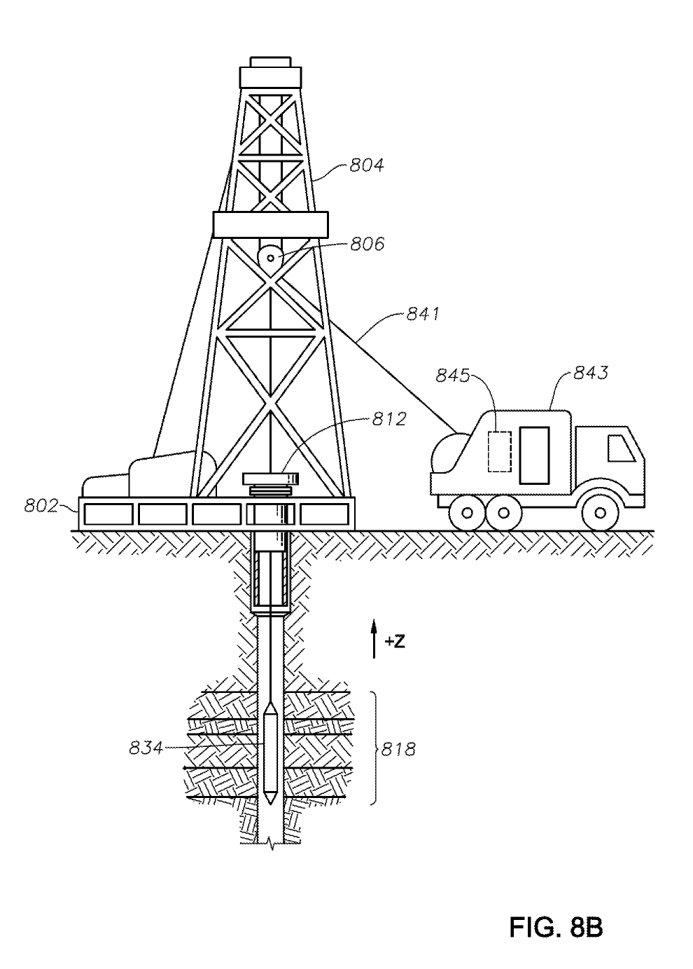

Now that a variety of alternative methods of the present disclosure have been described, illustrative applications will now be described. FIG. 8A illustrates an MCI logging tool, utilized in an LWD application, that acquires MCI measurement signals processed using the illustrative methods described herein. The methods described herein may be performed by a system control center located on the logging tool or may be conducted by a processing unit at a remote location, such as, for example, the surface.

FIG. 8A illustrates a drilling platform 802 equipped with a derrick 804 that supports a hoist 806 for raising and lowering a drill string 808. Hoist 806 suspends a top drive 810 suitable for rotating drill string 808 and lowering it through well head 812. Connected to the lower end of drill string 808 is a drill bit 814. As drill bit 814 rotates, it creates a wellbore 816 that passes through various layers of a formation 818. A pump 820 circulates drilling fluid through a supply pipe 822 to top drive 810, down through the interior of drill string 808, through orifices in drill bit 814, back to the surface via the annulus around drill string 808, and into a retention pit 824. The drilling fluid transports cuttings from the borehole into pit 824 and aids in maintaining the integrity of wellbore 816. Various materials can be used for drilling fluid, including, but not limited to, a salt-water based conductive mud.

An MCI logging tool 826 is integrated into the bottom-hole assembly near the bit 814. In this illustrative embodiment, MCI logging tool 826 is an LWD tool; however, in other illustrative embodiments, MCI logging tool 826 may be utilized in a wireline or tubing-conveyed logging application. In certain illustrative embodiments, MCI logging tool 826 may be adapted to perform logging operations in both open and cased hole environments.

As drill bit 814 extends wellbore 816 through formations 818, MCI logging tool 826 collects measurement signals relating to various formation properties, as well as the tool orientation and various other drilling conditions. In certain embodiments, MCI logging tool 826 may take the form of a drill collar, i.e., a thick-walled tubular that provides weight and rigidity to aid the drilling process, and may include an induction or propagation resistivity tool to sense geology and resistivity of formations. A telemetry sub 828 may be included to transfer images and measurement data/signals to a surface receiver 830 and to receive commands from the surface. In some embodiments, telemetry sub 828 does not communicate with the surface, but rather stores logging data for later retrieval at the surface when the logging assembly is recovered.

Still referring to FIG. 8A, MCI logging tool 826 includes a system control center (“SCC”), along with necessary processing/storage/communication circuitry, that is communicably coupled to one or more sensors (not shown) utilized to acquire formation measurement signals reflecting formation parameters. In certain embodiments, once the measurement signals are acquired, the system control center performs the methods describes herein, and then communicates the data back uphole and/or to other assembly components via telemetry sub 828. In an alternate embodiment, the system control center may be located at a remote location away from MCI logging tool 826, such as the surface or in a different borehole, and performs the processing accordingly. These and other variations within the present disclosure will be readily apparent to those ordinarily skilled in the art having the benefit of this disclosure.

The logging sensors utilized along logging tool 826 are resistivity sensors, such as, for example, magnetic or electric sensors, and may communicate in real-time. Illustrative magnetic sensors may include coil windings and solenoid windings that utilize induction phenomenon to sense conductivity of the earth formations. Illustrative electric sensors may include electrodes, linear wire antennas or toroidal antennas that utilize Ohm's law to perform the measurement. In addition, the sensors may be realizations of dipoles with an azimuthal moment direction and directionality, such as tilted coil antennas. In addition, the logging sensors may be adapted to perform logging operations in the up-hole or downhole directions. Telemetry sub 828 communicates with a remote location (surface, for example) using, for example, acoustic, pressure pulse, or electromagnetic methods, as will be understood by those ordinarily skilled in the art having the benefit of this disclosure.

MCI logging tool 826 may be, for example, a deep sensing induction or propagation resistivity tool. As will be understood by those ordinarily skilled in the art having the benefit of this disclosure, such tools typically include one or more transmitter and receiver coils that are axially separated along the wellbore 816. The transmitter coils generate alternating displacement currents in the formation 818 that are a function of conductivity. The alternating currents generate voltage at the one or more receiver coils. In addition to the path through the formation 818, a direct path from the transmitter coil(s) to receiver coil(s) also exists. In induction tools, signal from such path can be eliminated by the use of an oppositely wound and axially offset “bucking” coil. In propagation tools, phase and amplitude of the complex-valued voltage can be measured at certain operating frequencies. In such tools, it is also possible to measure phase difference and amplitude ratio between of the complex-valued voltages at two axially spaced receivers. Furthermore, pulse-excitation excitation and time-domain measurement signals can be used in the place of frequency domain measurement signals. Such measurement signals can be transformed into frequency measurements by utilizing a Fourier transform. The calibration methods described below are applicable to all of these signals and no limitation is intended with the presented examples. Generally speaking, a greater depth of investigation can be achieved using a larger transmitter-receiver pair spacing, but the vertical resolution of the measurement signals may suffer. Accordingly, logging tool 826 may employ multiple sets of transmitters or receivers at different positions along the wellbore 816 to enable multiple depths of investigation without unduly sacrificing vertical resolution.

FIG. 8B illustrates an alternative embodiment of the present disclosure whereby a wireline MCI logging tool acquires and processes the MCI measurement signals. At various times during the drilling process, drill string 808 may be removed from the borehole as shown in FIG. 8B. Once drill string 808 has been removed, logging operations can be conducted using a wireline MCI logging sonde 834, i.e., a probe suspended by a cable 841 having conductors for transporting power to the sonde and telemetry from the sonde to the surface. A wireline MCI logging sonde 834 may have pads and/or centralizing springs to maintain the tool near the axis of the borehole as the tool is pulled uphole. MCI Logging sonde 834 can include a variety of sensors including a multi-array laterolog tool for measuring formation resistivity. A logging facility 843 collects measurements from the MCI logging sonde 834, and includes a computer system 845 for processing and storing the measurements gathered by the sensors, as described herein.

In certain illustrative embodiments, the system control centers utilized by the MCI logging tools described herein include at least one processor embodied within system control center and a non-transitory and computer-readable medium, all interconnected via a system bus. Software instructions executable by the processor for implementing the illustrative MCI data quality assessment methods described herein in may be stored in local storage or some other computer-readable medium. It will also be recognized that the MCI processing software instructions may also be loaded into the storage from a CD-ROM or other appropriate storage media via wired or wireless methods.

Moreover, those ordinarily skilled in the art will appreciate that various aspects of the disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. The disclosure may be practiced in distributed-computing environments where tasks are performed by remote-processing devices that are linked through a communications network. In a distributed-computing environment, program modules may be located in both local and remote computer-storage media including memory storage devices. The present disclosure may therefore, be implemented in connection with various hardware, software or a combination thereof in a computer system or other processing system.

Accordingly, the illustrative methods described herein provide integrated data-quality assessment of inverted horizontal and vertical resistivities, dip, and dip azimuth (or strike) with multi-sensor log data. After addition of the methods herein for data quality assessment, new workflows for multi-resistivity data processing and interpretation may also be developed. When compared to conventional approaches that use the misfit error technique, methods of the present disclosure explicitly incorporate all of the available information from Rh, Rv, Rvh, and dip plus oval hole, formation invasion, shoulder effect and BA anisotropy information, which lead to improved data quality assessment and also assist the formation reservoir solutions to deeply understand the data quality for log interpretation.

Embodiments of the present disclosure described herein further relate to any one or more of the following paragraphs:

1. A method for processing multi-component induction (“MCI”) logging measurement signals using data-quality assessment, the method comprising: acquiring an MCI measurement signal of a formation using a logging tool extending along a borehole; processing the MCI measurement signal using a borehole formation model to thereby determine preliminary formation property data corresponding to the processed MCI measurement signal; assessing data-quality of the preliminary formation property data using one or more quality indicator(s) (“QI”); selecting a QI borehole formation model based upon the data-quality assessment; and processing the MCI measurement signal using the QI borehole formation model to thereby determine final formation property data corresponding to the processed MCI measurement signal.

2. A method as defined in paragraph 1, wherein assessing the data-quality comprises applying one or more of an oval-hole effect QI, formation-invasion effect QI, shoulder effect QI, biaxial anisotropy effect QI, or dip-difference effect QI to the preliminary formation property data.

3. A method as defined in paragraph 1 or 2, wherein processing the MCI measurement signal using the QI borehole formation model comprises performing an inversion on the final formation property data using the QI borehole formation model.

4. A method as defined in any of paragraphs 1-3, further comprising applying one or more weight functions to the inverted final formation property data, the one or more weight functions reflecting resistivity effects on the inverted final formation property data.

5. A method as defined in any of paragraphs 1-4, further comprising applying one or more weight functions to the inverted final formation property data, the one or more weight functions reflecting dip effects on the inverted final formation property data.

6. A method as defined in any of paragraphs 1-5, wherein the final formation property data is output as one or more of a formation horizontal resistivity, formation vertical resistivity, dip, or azimuth.

7. A method as defined in any of paragraphs 1-6, further comprising determining one or more of formation porosity, saturation, or permeability using the final formation property data.

8. A method as defined in any of paragraphs 1-8, wherein the logging tool forms part of a logging while drilling or wireline assembly.

9. A multi-component induction (“MCI”) logging tool, comprising one or more sensors to acquire MCI measurement signals, the sensors being communicably coupled to processing circuitry to implement a method comprising: acquiring an MCI measurement signal of a formation using a logging tool extending along a borehole; processing the MCI measurement signal using a borehole formation model to thereby determine preliminary formation property data corresponding to the processed MCI measurement signal; assessing data-quality of the preliminary formation property data using one or more quality indicator(s) (“QI”); selecting a QI borehole formation model based upon the data-quality assessment; and processing the MCI measurement signal using the QI borehole formation model to thereby determine final formation property data corresponding to the processed MCI measurement signal.

10. An MCI logging tool as defined in paragraph 9, wherein assessing the data-quality comprises applying one or more of an oval-hole effect QI, formation-invasion effect QI, shoulder effect QI, biaxial anisotropy effect QI, or dip-difference effect QI to the preliminary formation property data.

11. An MCI logging tool as defined in paragraphs 9 or 10, wherein processing the MCI measurement signal using the QI borehole formation model comprises performing an inversion on the final formation property data using the QI borehole formation model.

12. An MCI logging tool as defined in any of paragraphs 9-11, further comprising applying one or more weight functions to the inverted final formation property data, the one or more weight functions reflecting resistivity effects on the inverted final formation property data.

13. An MCI logging tool as defined in any of paragraphs 9-12, further comprising applying one or more weight functions to the inverted final formation property data, the one or more weight functions reflecting dip effects on the inverted final formation property data.

14. An MCI logging tool as defined in any of paragraphs 9-13, wherein the final formation property data is output as one or more of a formation horizontal resistivity, formation vertical resistivity, dip, or azimuth.

15. An MCI logging tool as defined in any of paragraphs 9-14, further comprising determining one or more of formation porosity, saturation, or permeability using the final formation property data.

16. An MCI logging tool as defined in any of paragraphs 9-15, wherein the logging tool forms part of a logging while drilling or wireline assembly.

Moreover, the foregoing paragraphs and other methods described herein may be embodied within a system comprising processing circuitry to implement any of the methods, or a in a non-transitory computer-readable medium comprising instructions which, when executed by at least one processor, causes the processor to perform any of the methods described herein.

Although various embodiments and methods have been shown and described, the disclosure is not limited to such embodiments and methods and will be understood to include all modifications and variations as would be apparent to one skilled in the art. Therefore, it should be understood that the disclosure is not intended to be limited to the particular forms disclosed. Rather, the intention is to cover all modifications, equivalents and alternatives falling within the spirit and scope of the disclosure as defined by the appended claims.

1. A method for processing multi-component induction (“MCI”) logging measurement signals using data-quality assessment, the method comprising:
acquiring an MCI measurement signal of a formation using a logging tool extending along a borehole;
processing the MCI measurement signal using a borehole formation model to thereby determine preliminary formation property data corresponding to the processed MCI measurement signal;
assessing data-quality of the preliminary formation property data using one or more quality indicator(s) (“QI”);
selecting a QI borehole formation model based upon the data-quality assessment; and
processing the MCI measurement signal using the QI borehole formation model to thereby determine final formation property data corresponding to the processed MCI measurement signal.

2. A method as defined in claim 1, wherein assessing the data-quality comprises applying one or more of an oval-hole effect QI, formation-invasion effect QI, shoulder effect QI, biaxial anisotropy effect QI, or dip-difference effect QI to the preliminary formation property data.

3. A method as defined in claim 1, wherein processing the MCI measurement signal using the QI borehole formation model comprises performing an inversion on the final formation property data using the QI borehole formation model.

4. A method as defined in claim 3, further comprising applying one or more weight functions to the inverted final formation property data, the one or more weight functions reflecting resistivity effects on the inverted final formation property data.

5. A method as defined in claim 3, further comprising applying one or more weight functions to the inverted final formation property data, the one or more weight functions reflecting dip effects on the inverted final formation property data.

6. A method as defined in claim 1, wherein the final formation property data is output as one or more of a formation horizontal resistivity, formation vertical resistivity, dip, or azimuth.

7. A method as defined in claim 1, further comprising determining one or more of formation porosity, saturation, or permeability using the final formation property data.

8. A method as defined in claim 1, wherein the logging tool forms part of a logging while drilling or wireline assembly.

9. A multi-component induction (“MCI”) logging tool, comprising one or more sensors to acquire MCI measurement signals, the sensors being communicably coupled to processing circuitry to implement a method comprising:
acquiring an MCI measurement signal of a formation using a logging tool extending along a borehole;
processing the MCI measurement signal using a borehole formation model to thereby determine preliminary formation property data corresponding to the processed MCI measurement signal;
assessing data-quality of the preliminary formation property data using one or more quality indicator(s) (“QI”);
selecting a QI borehole formation model based upon the data-quality assessment; and
processing the MCI measurement signal using the QI borehole formation model to thereby determine final formation property data corresponding to the processed MCI measurement signal.

10. An MCI logging tool as defined in claim 9, wherein assessing the data-quality comprises applying one or more of an oval-hole effect QI, formation-invasion effect QI, shoulder effect QI, biaxial anisotropy effect QI, or dip-difference effect QI to the preliminary formation property data.

11. An MCI logging tool as defined in claim 9, wherein processing the MCI measurement signal using the QI borehole formation model comprises performing an inversion on the final formation property data using the QI borehole formation model.

12. An MCI logging tool as defined in claim 11, further comprising applying one or more weight functions to the inverted final formation property data, the one or more weight functions reflecting resistivity effects on the inverted final formation property data.

13. An MCI logging tool as defined in claim 11, further comprising applying one or more weight functions to the inverted final formation property data, the one or more weight functions reflecting dip effects on the inverted final formation property data.

14. An MCI logging tool as defined in claim 9, wherein the final formation property data is output as one or more of a formation horizontal resistivity, formation vertical resistivity, dip, or azimuth.

15. An MCI logging tool as defined in claim 9, further comprising determining one or more of formation porosity, saturation, or permeability using the final formation property data.

16. An MCI logging tool as defined in claim 9, wherein the logging tool forms part of a logging while drilling or wireline assembly.

17. A non-transitory computer-readable medium comprising instructions which, when executed by at least one processor, causes the processor to perform a method as defined in claim 1.
